(19) United States
(12) Patent Application Publication
(10) Pub. No.: US 2023/0036282 A1
(43) Pub. Date: Feb. 2, 2023

(54) METHOD FOR OBTAINING A GRANULATED FOOD MATERIAL

(71) Applicants: INDUSTRIA COLOMBIANA DE CAFÉ S.A.S., Medellín (CO); UNIVERSIDAD DE ANTIOQUIA, Medellín (CO)

(72) Inventors: Catalina María CORDOBA HENAO, Medellín (CO); Alvin De Jesús LÓPEZ LÓPEZ, Medellín (CO); Mauricio NARANJO CANO, Medellín (CO); John Jairo ROJAS CAMARGO, Medellín (CO)

(21) Appl. No.: 17/634,882

(22) PCT Filed: Aug. 12, 2020
(86) PCT No.: PCT/IB2020/057605

§ 371 Date: Sep. 7, 2022

(30) Foreign Application Priority Data
Aug. 12, 2019 (CO) NC2019/0008712

(51) Int. Cl. A23F 3/32; A23F 5/38; A23G 1/56; A23G 4/20

(52) U.S. Cl. CPC A23F 3/32; A23F 5/38; A23G 1/56; A23G 4/20

(57) ABSTRACT

This invention is directed to a method for the production of a granular food material from a powder, agglomerate or lyophilized product obtained from coffee, coffee substitutes, mixtures of coffee with milks or derivatives, tea tree, cocoa, soy, quinoa, malt, tea, cinnamon or cloves, comprising the stages of dry compression, comminution and optionally fractioning. Obtaining a product that preserves its aromatic properties for a longer period of time.

### FIELD OF THE INVENTION

This invention relates to the food industry, in particular to a method for obtaining a food material such as coffee, malt, cocoa, tea, soy, quinoa, coffee substitutes, mixtures of coffee with milks or derivatives and other foods, and the product obtained by means thereof.

### DESCRIPTION OF THE PRIOR ART

Among the different presentations of coffee, there is instant coffee, wherein the user prepares the coffee beverage by mixing a solid coffee product and a liquid, such as hot or cold water or milk. Traditionally, the method to obtain instant coffee consists of loading ground coffee in columns called percolators through which hot water is pumped, resulting in a coffee concentrate or extract that is subsequently dried (either by atomization or lyophilization) obtaining in this way a coffee powder or lyophilized coffee.

Other methods for obtaining instant beverages are also known, e.g., by drying coffee, cocoa, soybean or tea extracts, such as freeze-drying, or combining dry powders and extracts of several concentrations, and other methods for agglomeration of particulate material, e.g., by using a wet binder.

For example, there is EP0373697 describing the formation of a granular product from a powdered extract by percolation of a dry powdered extract, in an environment not exposed to air, in order to form an agglomerate in which particles of the powdered extract material are retained during sintering.

There is also U.S. Pat. No. 4,154,864 which discloses a method for producing a powder for reconstitution in water, comprising the steps of providing a porous particulate base powder, sintering said powder to form an agglomerated cake and texturizing said cake to obtain the instant drink powder. The porous particulate base powder is produced from a base powder heated above its glass transition temperature and, subsequently, sintered to form an agglomerated cake in which a light compaction pressure can be applied to the hot powder.

On the other hand, US20050266134 discloses a method for producing a granulated flavoring that comprises forcing a powdered flavoring and a vehicle through a horizontal screw to obtain a flavoring in the form of a pressed powder, compacting the pressed flavoring with rollers until a partially molten flat material is obtained, grinding and, finally, granulating said material.

Moreover, U.S. Pat. No. 6,497,911 discloses a method for the preparation of a water-soluble coffee or tea particulate product, comprising heat treatment of a particulate material with a moisture content, higher than that of the final product. The heat treatment retains the appropriate moisture, which allows the particulate material to form sheets which subsequently fuse together to form a compact cake-like structure, which is then disintegrated into a granular material and finally dried to the desired moisture content.

Finally, there is US20110039007, which discloses plant extracts in the form of grains that dissolve instantaneously in water, have continuous porous structure, smooth surface and bulk density of 300 g/L. This document also discloses a method for the production of said thermoplastic plant extract, comprising extruding a dehydrated plant extract (such as coffee, chicory, tea and herbal decoctions) in the form of powder or paste with a moisture content of up to 10% in a chamber where a sub-atmospheric pressure prevails (between 60 and 125° C. and 0.01 to 0.3 atm) and the subsequent cutting of the extruded product, into fragments.

Among the drawbacks or technical problems faced by the prior art, it is essential to apply partial wetting to the starting material, which allows modifying its glass transition and subsequently subjecting it to partial compaction and/or sintering, which could lead to the oxidation of some polyphenolic components or generate slight temperature changes that may cause undesirable changes in the sensory properties of the product such as odor, color and flavor. In addition, the series of unit operations currently known makes their production difficult, on an industrial scale, not very reproducible and with high energy costs.

### BRIEF DESCRIPTION OF THE INVENTION

This invention proposes a production method of easy operation and highly reproducible. In particular, it is directed to a method for obtaining a soluble granular food product, which is obtained from a particulate food material comprising the stages of dry compressing until an ingot is obtained; and comminuting the ingot obtained until a soluble granular food material is obtained, optionally fractioning it until a soluble granular food product with a particle size between 100 μm and 10 mm is obtained. The particulate food material can be a powder, agglomerated or lyophilized obtained from dry extracts, coffee powder or agglomerate, tea tree, cocoa, soy, quinoa, malt, tea, cinnamon or cloves.

### BRIEF DESCRIPTION OF THE FIGURES

FIG. 1 shows microphotographs of the starting material coffee powder (starting material 1) at 250 μm and 40× magnification.

FIG. 2 shows microphotographs of the agglomerated starting material (starting material 2) at 250 μm and 40× magnification. The agglomerated starting material is obtained by steam treatment of coffee powder.

FIG. 3 shows micrographs of the lyophilized starting material (starting material 3) in (a) optical micrographs at 250 μm (40×), (b) ×100 electron micrograph; 100 μm and (c) ×1000 electron micrograph; 10 μm.

FIG. 4 shows micrographs of the finished product of Example 1 without additives (a) optical micrograph at 250 μm, (b) electron micrograph at ×100; 100 μm and (c) electron micrograph at ×1000; 10 μm.

FIG. 5 shows microphotographs of the finished product of Example 2, AE PPD at 250 μm scale and 40× magnification.

FIG. 6 shows micrographs of the finished product of Example 3, AE PPD EFER in (a) optical micrograph at 250 μm (40×), (b) ×1000 electron micrograph; 10 μm and (c) ×100 electron micrograph; 100 μm.

FIG. 7 shows micrographs of the finished product of Example 4, coffee powder with roasted coffee and 5% micro-milling in (a) optical micrograph at 250 μm (40×), (b) electron micrograph ×1000; 10 μm and (c) electron micrograph ×100; 100 μm.

FIG. 8 shows micrographs of the finished product of Example 5, cocoa in (a) optical micrograph at 250 μm (40×), (b) electron micrograph ×1000; 10 μm and (c) electron micrograph ×100; 100 μm.

FIG. 9 shows microphotographs of the finished product of Example 6, agglomerated coffee followed by dry compression and 40× magnification.

FIG. 10 shows microphotographs of the coated finished product of Example 7, wherein nitrogen injection is evaluated with 0.5-inch punches, and 40× magnification.

FIG. 11 shows microphotographs of the finished product of Example 8, wherein the method is evaluated at 12 MPa pressure.

FIG. 12 shows microphotographs of the finished product of Example 9, wherein the method is evaluated with a cold brew type starting material extracted at low temperatures.

FIG. 13 shows microphotographs of the finished product of Example 10, wherein the compression reprocessing effect of the intermediate fraction is evaluated.

FIG. 14 shows microphotographs of the finished product of Example 11, wherein the compression reprocessing effect of the fine fraction is evaluated.

FIG. 15 shows comparative gas chromatographic analyses for volatile compounds in samples 1 and 2, compared with a standard (a) 1H-pyrrole-2-carboxaldehyde, (b) 1-hydroxy 2-propanone.

### DETAILED DESCRIPTION

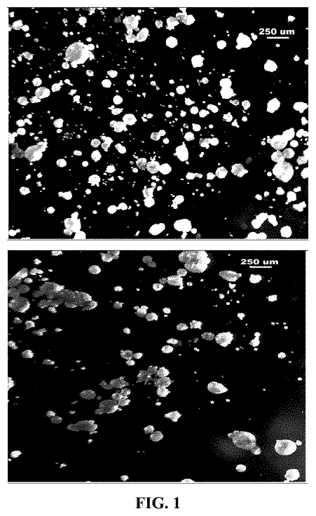

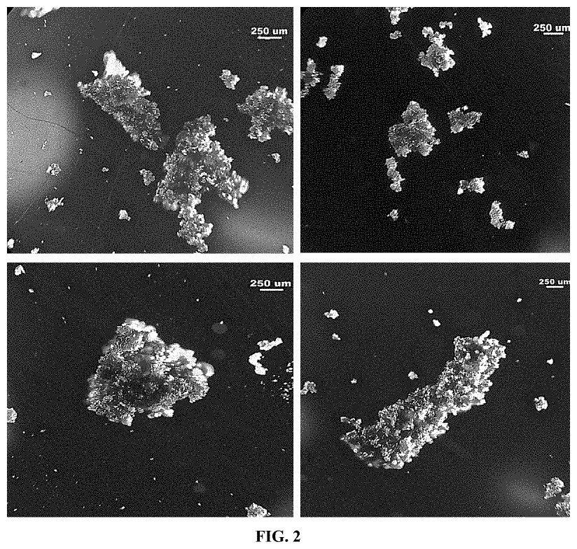

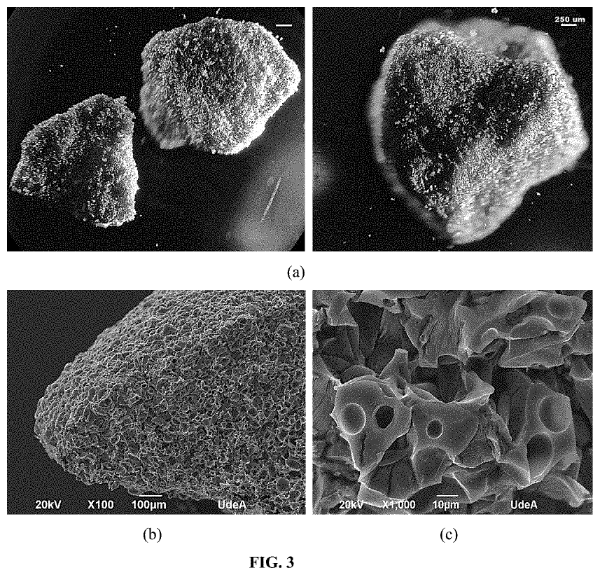

Overall, this invention is directed to a method for obtaining a granular food product, soluble in an aqueous or partially aqueous medium, which is obtained from a particulate food material comprising the stages of dry compressing until an ingot is obtained; and comminuting the ingot obtained resulting in a soluble granular food product with a particle size between 100 μm and 10 mm. The starting particulate food material may be a powder, agglomerated or lyophilized (for example as seen in FIG. 1, FIG. 2 and FIG. 3, respectively), obtained from dried extracts, coffee powder or agglomerate, tea tree, cocoa, soybean, quinoa, malt, tea, cinnamon or cloves.

The method for obtaining soluble granular food product, provides products with different particle sizes and morphology. In particular, it is directed to a method for producing an aggregate of coffee, tea, malt, cocoa, herbal teas, soy solubles, useful for producing instant beverages from a particulate food material, in a fast and economical industrial mass production giving typical, distinctive and desirable sensory qualities to the product. It requires fewer unitary operations than those disclosed in the prior art, which leads to a decrease in energy expenditure and production time. This method is carried out in an industrial line procedure, in series or batches. Among the results of the method, there is the reduction of the number of unit operations and processing energy, in addition to eliminating waste by giving adequate particle sizes without requiring other intermediate methods, such as agglutination with wetting agents and addition of water vapor or other solvents and/or heating application.

By means of the method in this invention, a granular food product is obtained with different features such as high porosity (between 50 and 95%), fast solubility (between 0 and 25 s), high aspect ratio (between 0.5 and 0.95), high densification (between 0.1 and 1 g/cm³), low humidity and hygroscopicity (between 0 and 10%), which guarantee a product with better mechanical resistance, greater stability and better physical appearance and preservation of sensory properties such as light color, characteristic odor and flavor due to the prevalence and preservation of characteristic aromatic compounds. This preserves the shelf life of the product during storage, marketing and consumption.

The method of the present application avoids thermal degradation and the formation of undesirable flavors and aromas in the finished product, which usually occur when using other processes involving wetting and heating as described in the prior art.

Preferably, the method is performed at low relative humidity levels and low ambient oxygen, wherein “low ambient relative humidity” means an ambient humidity of less than 75% and “low ambient oxygen” means oxygen values of less than 22%. The method can be carried out in batches or continuously, wherein the fine and intermediate by-products can be reprocessed by reincorporating them in the compression, comminution or fractionation stages.

The input material to the process or “particulate food material” corresponds to a powder, agglomerated or lyophilized, or other type of intermediate morphology or fractions. Among the morphologies of particulate food material are but not limited to spherical, hemispherical, oval, irregular, polyhedral, fibrous, columnar, elongated, acicular, among others known to a person moderately versed in the matter.

The powder, agglomerated or lyophilized product is characterized in that it is obtained from a dry extract, liquid extract, soluble extract, coffee powder, tea tree, cocoa, malt, tea, soybean, quinoa, cinnamon, cloves, fruits and/or combinations thereof. The powder, agglomerate or lyophilized product can be obtained by spray drying of a liquid extract, by steam agglutination, by concentration of the extract at temperatures below 40° C. and ultra-vacuum around 133 Pa, respectively, or according to the understanding of a person moderately skilled in the art.

For the purposes of this invention, “dust” is understood to mean particulate material with a particle size between 50 μm and 1,0000 μm, between 50 μm and 500 μm, or between 100 μm and 300 μm. For the purposes of this invention, “agglomerate” is understood to mean particulate material between 500 μm and 5,000 μm, between 1,000 μm and 3,000 μm, preferably between 2,000 μm and 2,500 μm, around 2,300 μm. Finally, for the purposes of this invention, “lyophilized” is understood to mean particulate material with a particle size between 500 μm and 5,000 μm, between 1,500 μm and 4,000 μm, preferably between 2,500 μm and 3,500 μm, about 3,000 μm.

The particulate food material is optionally obtained by cold extraction means or at room temperature. Cold brew means extraction by successive percolations or not, and at room temperature below 60° C., between 2° C. and 60° C., between 2° C. and 40° C., preferably between 5° C. and 25° C., or around 18° C. However, conventionally the particulate food material can also be obtained by extractions at temperatures between 40° C. and 200° C.

The particulate food material used for the method of this invention, preferably has a moisture content between 1% and 15%, between 1% and 10%, between 3% and 7%, between 1% and 7%, between 1% and 7%, less than 15%, less than 5%, or about 3%.

The particulate food material is optionally obtained by injection of any suitable inert gas, such as nitrogen, carbon dioxide, air, oxygen, helium, hydrogen, argon, neon, methane, ethane, krypton, chlorine, chlorofluorocarbons or mixtures thereof, or any other that does not adversely affect the other component of the powder or human use. Gas injection can be done by pressure homogenization of the extract prior to spray drying, so it remains within the particles. The pressure and residence time of the gas increase the porosity of the particulate material. The gas is retained within the particles when they are formed during spray drying.

### Additives in Particulate Food Material

Optionally, additives are added to the particulate food material, including but not limited to: antioxidants, multivitamins, minerals, flavorings, solubilizers, disintegrants, probiotics, prebiotics, flavonoids, polyphenols, and/or combination thereof, or any other additives known to a person moderately skilled in the art. For example, disintegrants include but are not limited to polyplasdone, polyols, carrageenan, sugars, starches, croscarmellose, sodium starch glycolate, effervescent salts, carbonated salts, and/or combination thereof.

One or more additives can also be added to the particulate food material such as: flavor enhancers such as vanilla, chocolate, chocolate mint, cocoa, chocolate liqueurs, almond nut, amaretto, anise, apple, brandy, cappuccino, chamomile, cherry, cinnamon, green tea, crème de menthe, French vanilla, grand mariner, grape, herbal blends, Irish cream, kahlua, citrus essences, peach, pistachio, raspberry, strawberry and the like, flavorings such as acetaldehyde, caloric or non-caloric sweeteners, dairy components, non-dairy components, spices, and/or combinations thereof.

The particulate food material can also have other additives such as roasted coffee, micro-milled coffee, sugars, natural polymers, maltodextrin, cyclodextrins, malt extract, proteins, hydrocolloids, fats, corn syrup, foam destabilizing agents, and lubricants. Natural polymers include gums, alginates, hemicellulose, cellulose ethers and esters, chitosan, pectins, soluble starch and modified starch. Sugars include lactose, dextrose, fructose, sucrose, steviosides, rebaudiosides, and sorbitol, wherein, among the lubricants, there are stearic acid and its salts, talc, monoesters, polyols, oleic acid, isopropyl myristate, silicones, mono/diesteryl monostearate mixtures, or combinations thereof, wherein foam destabilizing agents include isopropanol, fats, lipids, vitamins and phospholipids.

The additives may be added to the particulate food material in a proportion between 0.01% and 20% of the particulate food material, preferably between 0.25% and 5%, between 0.5% and 1%, or about 1%. The particulate food material constitutes at least 90% by weight of the matrix, preferably more than 95% of the matrix and more preferably minimum 99% by weight of the matrix.

Additives can be added during spray drying of a liquid extract, water vapor agglutination, or by concentration of the extract at temperatures below −40° C. and ultra-vacuum below 133 Pa, or any other previous methods to obtain the particulate food material or just before compression. In case additives are added, this stage is called blending.

### Compression

Compression of a particulate food material corresponds to dry compression. Dry compression refers to the compaction of the particulate food material to reduce its initial volume, without the addition of aqueous or organic solvents or their vapors.

Dry compression preferably occurs in an atmosphere with low relative humidity, for example below 75%, below 50%, between 25% and 50%, between 25% and 80%, or between 30% and 40%. Optionally it is performed in an atmosphere with an oxygen content between 1% and 22%, preferably between 5% and 20%, more preferably between 10% and 15%. This allows a good flow of the material in the dies and preserves the punching.

Dry compression occurs between 5 MPa and 1,000 MPa, between 10 MPa and 1,000 MPa, between 10 MPa and 600 MPa, between 20 MPa and 200 MPa, between 20 MPa and 80 MPa, around 25 MPa. As mentioned above, compression is performed to a particulate food material as described above, this method can be performed for example in a tablet press, die cutter or compactor until an ingot or tablet is obtained. By “ingot” or “tablet” it is understood a solid compressed form of different geometries such as: circular, triangular, square, capsular, rectangular, spherical, striated, concave, convex and others, formed by primary particles adhered to each other. These can be septate, beveled or simple.

Wherein the ingot or tablet obtained after compression is characterized in that it has: a diameter of less than 30 cm, less than 10 cm, between 8 mm and 30 mm, between 12 mm and 25 mm, or about 25 mm. This ingot or tablet obtained after compression is characterized in that it has a mass of less than 200 g, less than 50 g, between 0.5 g and 30 g, between 1 g and 10 g, or about 5 g. Additionally, the ingot or tablet obtained after compression is characterized in that it has a thickness of less than 20 mm, less than 10 mm, between 2 mm and 20 mm, between 3.5 mm and 5 mm, about 3 mm. Additionally, the ingot or tablet obtained after compression is characterized in that it has a porosity between 20% and 70%, between 30% and 40%, preferably between 25% and 35%, or about 30%.

The compression step can be repeated until an ingot or tablet is obtained, with the desired features of diameter, thickness, mass and porosity, described above.

### Comminution

After compression, the method continues with a comminution stage, wherein the particle size of the ingot or tablet previously obtained is reduced. For example, comminution is performed by crushing or shredding large particles into smaller particles until a granular material is obtained. Granular material is defined as a powder, agglomerate or lyophilized material with a particle size between 250 μm and 10 mm, between 400 μm and 8 mm, or between 600 μm and 5 mm. For example, passing through a #8 stainless steel mesh, with a particle size of less than 2,380 μm or a #6 stainless steel mesh.

The granular material has a polyhedral morphology with an aspect ratio up to 1, between 0.5 and 0.95, between 0.60 and 0.75, between 0.69 and 0.75, between 0.65 and 0.8, between 0.7 and 0.95, depending on the compression force used, since low compression forces and higher porosity produce aspect ratios much closer to 1. The aspect ratio is the quotient of the axial and equatorial diameter of the particle, the smaller of the two being in the numerator. Polyhedral morphology is a geometric body bounded by planar faces or by a finite number of planar surfaces hosting a finite three-dimensional volume.

The comminution stage can be performed by, e.g., a vibrating screen, cascade impactor, mechanical sweeping, gravitational acceleration, air jets and/or any other method known to a person moderately skilled in the art. At speeds between 5 rpm and 60 rpm, between 10 rpm and 40 rpm and between 15 rpm and 25 rpm, or as required to obtain the desired particle size.

Optionally, after comminution, the soluble granular food material is coated with an oily substance including but not limited to: fatty acid and alcohol esters, waxes, coffee oil, unsaturated fatty acids, oils of vegetable origin, omega 3, carotenes, phytosterols, oleophilic vitamins and/or combination thereof. Oily substances include but are not limited to coffee oil, cocoa butter or polymeric compounds. Polymeric compounds include but are not limited to maltodextrin, silicones, mineral oil, modified starch, corn syrup, gum and/or combination thereof. Oils of vegetable origin include but are not limited to coffee, canola, sunflower, sesame, essential oils, and cocoa butter.

The comminution step can be repeated until a granular material is obtained, with the particle size features described above.

### Fractioning

Optionally, a fractioning step can be performed which consists of separating the material by particle size to obtain a product with the desired physical properties of particle size. Fractioning is performed until a granular food product with a particle size between 100 μm and 20,000 μm, between 250 μm and 10,000 μm, between 600 μm and 5,000 μm, between 100 μm and 8,000 μm, preferably between 1,000 μm and 4,500 μm, or about 2,000 μm is obtained. This fractioning can be accomplished by means of a vibrating screen, cascade accelerator, mechanical sweeping, gravitational acceleration, air jets and/or combination thereof. For example, a vibrating screen larger than #30, with a pore size of 595 μm.

After fractioning, the soluble granular food material is optionally coated with an oily substance including but not limited to: fatty acid esters and alcohol, coffee oil, waxes, cocoa butter, polymeric compounds, unsaturated fatty acids, oils of vegetable origin, omega 3, carotenes, phytosterols, oleophilic vitamins and/or combination thereof. Among the polymeric compounds are but not limited to maltodextrin, waxes, silicones, mineral oil, modified starch, corn syrup, gum and/or combination thereof. Among the oils of vegetable origin are but not limited to coffee, canola, sunflower, sesame, essential oils, and cocoa butter.

The granular material is coated for example with coffee oil by means of microdroplet spraying. Particularly by microdroplet spraying, wherein the microdroplets have sizes between 250 μm and 1,000 μm, between 400 μm and 750 μm, or around 500 μm. For example, these are performed in a conventional drum, Accela cotta, fluidized bed, rotary processor, Wurster equipment or any other coating equipment known to the skilled in the art.

Fine and intermediate fragments that are outside the particle size conditions described above, can be fed back into the compression stage, until the desired particle size features described above are obtained.

For the purposes of this invention “around” is understood to mean a variation in the property of relative humidity, mass, thickness, oxygen level, compression pressure, particle size, density, porosity, of ±5%.

### Food Product

With the method of this invention a food product is obtained which corresponds to a soluble granular food product, i.e., a granule rapidly soluble in aqueous media of brighter color (compared to the particulate food material employed as input material), with characteristic sensory properties, high porosity, high densification and rough surface. In particular, a food granular material is obtained which is characterized in that it is soluble or partially soluble in an aqueous or partially aqueous medium.

Wherein “rapidly soluble” means a food product with a solubility between 5 s and 50 s, between 10 s and 40 s, preferably between 15 s and 30 s, more preferably between 10 s and 25 s, wherein “high porosity” means a product with a porosity between 50% and 95%, between 70% and 90%, between 55% and 75% or between 60% and 95%, wherein “high densification” means a density between 0.1 g/cm³ and 1 g/cm³, between 0.1 g/cm³ and 0.8 g/cm³, between 0.3 g/cm³ and 0.6 g/cm³, or between 0.4 g/cm³ and 0.6 g/cm³.

In particular, the food product of the invention is obtained from a powder, agglomerated or lyophilized coffee, soybean, quinoa, tea tree, cocoa, cacao, malt, tea, cinnamon, cloves and/or combinations thereof, which was subjected to a dry compression and subsequently comminuted. The food product may be coated with an oily substance, such as fatty acid esters and alcohol, coffee oil, unsaturated fatty acids, waxes, vegetable oils, essential oils, omega 3, carotenes, phytosterols, oleophilic vitamins, or combination thereof.

The food product obtained has a particle size that depends on the operating conditions of the method stages, for example, it has a size between 50 μm and 10,000 μm, between 1 μm and 5,000 μm, between 1 μm and 8,000 μm, between 800 μm and 3,000 μm, or between 2,000 μm and 5,000 μm, between 100 μm and 20,000 μm, between 250 μm and 10,000 μm, between 600 μm and 5,000 μm, between 100 μm and 8,000 μm, preferably between 1,000 μm and 4,500 μm, or about 2,000μm.

The food product is characterized by having a specific surface area between 10 m/g² and 100 m/g², between 20 m/g² and 80 m/g², preferably between 40 m/g² and 60 m/g². When compared with the input materials (particulate food material) after undergoing the method of this invention it is found that the surface area decreases significantly (as observed in Examples 1 to 11) this is because a denser and less porous product is obtained, which makes it more stable over time avoiding the escape of the typical product aromas or volatile compounds of the product, such as 1H-pyrrole-2-carboxaldehyde.

Among the characteristic sensory properties of the granular food material are the color, taste and odor space.

In relation to the color space, the product is characterized by its luminosity (L), chroma or saturation (C*), hue angle (h*), green intensity (a), blue intensity (b), wherein upon comparing the granular food material obtained by the method of this invention with an unprocessed coffee powder, it was observed that it presents an increase in luminosity between 1% and 50%, between 3% and 20%, between 5% and 15%, between 6% and 10% or about 7%.

In relation to the taste and odor properties, the product is characterized by its aroma, acidity, bitterness, body, and overall impression, wherein upon comparing the granular food material obtained by the method of this invention with an unprocessed powder, the product was observed to have an intense aroma. Additionally, the food product obtained presents an aromatic profile characterized by the compounds 1-H-pyrrole-2-carboxaldehyde and 1-hydroxy 2-propanone, which are not found intensified in the starting material (particulate food material).

### EXAMPLES

The following Examples illustrate the invention, without the inventive concept being restricted thereto:

TABLE 1
Features of some starting materials useful in the method
described in the invention.

| | Coffee | Agglomerated | Lyophilized |
|---|---|---|---|
| Property | powder | coffee | coffee |
| Compressibility (%) | 23.3 | 18.7 | 19.3 |
| Bulk density (g/cm³) | 0.14 | 0.23 | 0.22 |
| Settled density (g/cm³) | 0.18 | 0.28 | 0.26 |
| Carr Index (%) | 22.7 | 18.2 | 18.2 |
| Hausner Index | 1.29 | 1.22 | 1.22 |
| True density (g/cm³) | 0.727 | 1.407 | 1.35 |
| Porosity (%) | 81 | 83.8 | 84.1 |
| Diameter (mm) | 0.26 | 2.3 | 3.1 |
| Solubility (s) | 12 | 16 | 10 |
| Aspect ratio | 0.72 | 0.69 | 0.74 |
| Flow (g/s) | 25.3 | 31.5 | 21.6 |
| Friability (%) | N/A | 31.4 | 7.35 |
| Humidity (%) | 2.6 | 6.51 | 7.14 |
| Color scale (L) | 46.1 | 27.2 | 34.9 |
| Color scale (a) | 16.6 | 13.4 | 14.43 |
| Color scale (b) | 31 | 10.2 | 19.5 |
| Color scale (c) | 34.8 | 17 | 24.3 |
| Color scale (h) | 61.9 | 35.9 | 53.5 |

### Example 1. Method for the Production of Granular Food Product from Coffee Powder without Additives at Compression Conditions of 25 MPa

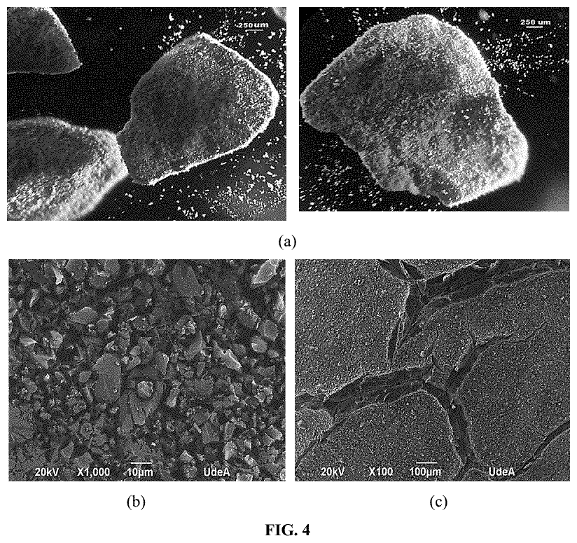

The particulate food material used in this example was a coffee powder (FIG. 4) that was previously spray dried (particle size 0.05 mm-0.5 mm) obtained by air injection between 1 gph-5 gph, followed by spray drying at air inlet 150° C.-620° C. and air outlet 60° C.-120° C. with atomization pressure between 10 Bar-30 Bar (1,000 kPa-3,000 kPa).

No additives were added to the dry powder and it was subjected to a dry compression stage, in particular an ingot in a 16-punch rotary tablet press (diameter 25.4 mm, height 3.9 mm, 3 g, porosity 20%) wherein the dry powder was compressed at a compression pressure of 25 MPa, at room temperature and relative humidity around 50%.

The ingots obtained were subjected to oscillating comminution coupled to a #8 stainless steel mesh and subsequent fractioning by meshes larger than #30. A granular material characterized by having the resulting properties listed in Table 2 and FIG. 4 is obtained.

TABLE 2

| Property | Product 1 |
|---|---|
| Compressibility (%) | 14.1 |
| Bulk density (g/cm³) | 0.51 |
| Settled density (g/cm³) | 0.59 |
| Carr Index (%) | 13.3 |
| Hausner Index | 1.15 |
| True density (g/cm³) | 1.477 |
| Porosity (%) | 65.4 |
| Diameter (mm) | 2.9 |
| Solubility (s) | 19 |
| Aspect ratio | 0.73 |
| Flow (g/s) | 49.4 |
| Brittleness (%) | 6.6 |
| Humidity (%) | 7.12 |
| Color scale (L) | 50.4 |
| Color scale (a) | 12.1 |
| Color scale (b) | 26.4 |
| Color scale (c) | 29 |
| Color scale (h) | 65.5 |

### Example 2 Method for the Production of Granular Food Product from Coffee Powder with Lubricant and Disintegrant at Compression Conditions of 25 MPa

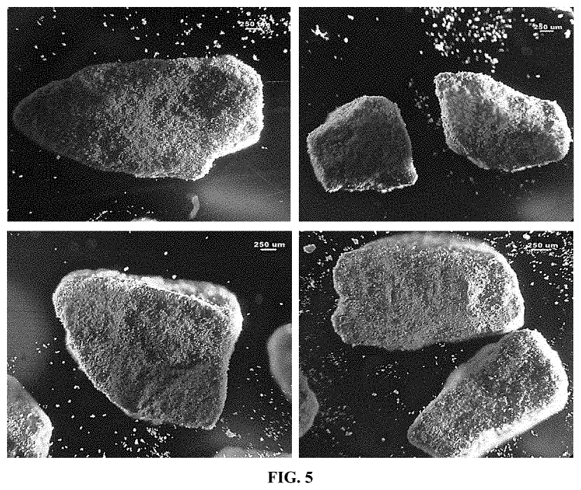

The particulate food material used in this example was a coffee powder (FIG. 5) which was previously obtained by spray drying (particle size 0.05 mm-0.5 mm) obtained by air injection between 1 gph-5 gph, followed by spray drying at air inlet 150° C.-620° C. and air outlet 60° C.-210° C. with atomization pressure between 10 Bar-30 Bar (1,000 kPa-3,000 kPa).

Lubricant and disintegrants were added to the dry powder obtained in an amount less than 1% W/W using an overturning mixer for 15 min and subjected to a dry compression stage, in particular to an ingot in a 16-punch rotary tablet press (diameter 25.4 mm, height 4.2 mm, 2 g, porosity 30%) compressed with a compression pressure of 25 MPa at room temperature and relative humidity around 40%.

The ingots obtained were subjected to comminution coupled to a #8 stainless steel mesh and subsequent fractioning by meshes larger than #30. A granular material characterized by having the resulting properties listed in Table 3 and FIG. 5 is obtained.

TABLE 3

| Property | Product 2 |
|---|---|
| Compressibility (%) | 12.3 |
| Bulk density (g/cm³) | 0.51 |
| Settled density (g/cm³) | 0.58 |
| Carr Index (%) | 12 |
| Hausner Index | 1.14 |
| True density (g/cm³) | 1.473 |
| Porosity (%) | 65.5 |
| Diameter (mm) | 2.7 |
| Solubility (s) | 22 |
| Aspect ratio | 0.73 |
| Flow (g/s) | 60.6 |
| Brittleness (%) | 7.3 |
| Humidity (%) | 4.1 |
| Color scale (L) | 47.9 |
| Color scale (a) | 11.2 |
| Color scale (b) | 25.1 |
| Color scale (c) | 27.6 |
| Color scale (h) | 66 |

### Example 3 Method for the Production of Granular Food Product from Coffee Powder with Lubricant, Disintegrant and Effervescent at 25 MPa Compression Conditions

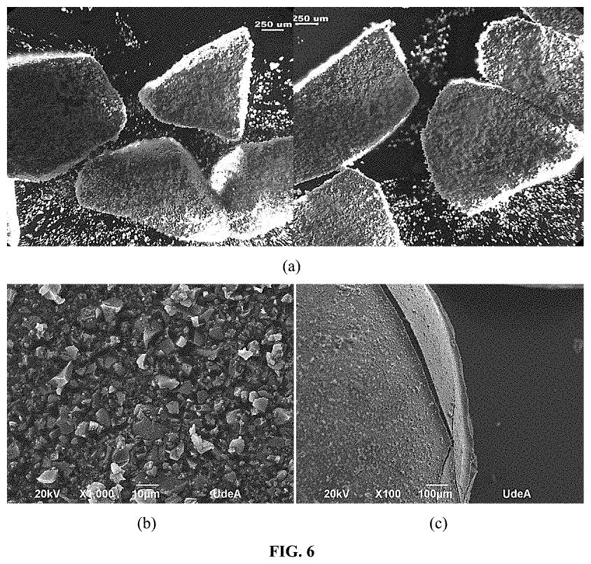

The particulate food material used in this example was a coffee powder (FIG. 6) that was previously spray dried (particle size 0.05 mm-0.5 mm) obtained by air injection between 1 gph-5 gph, followed by spray drying at air inlet 150° C.-620° C. and air outlet 60° C.-210° C. with atomization pressure between 10 Bar-30 Bar (1,000 kPa-3,000 kPa).

The dry powder obtained was added lubricant, disintegrants and effervescent less than 1% using an overturning mixer for 15 min and was subjected to a dry compression stage, in particular to ingot in a 16-punch rotary tablet press (diameter 25.4 mm, height 4.5 mm, 2.2 g, porosity 42%) with a compression pressure of 25 MPa at room temperature and relative humidity around 45%.

The ingots obtained were subjected to comminution coupled to a #8 stainless steel mesh and subsequent fractioning by meshes larger than #30. A granular material characterized by having the resulting properties listed in Table 4 and FIG. 6 is obtained.

TABLE 4

| Property | Product 3 |
|---|---|
| Compressibility (%) | 16.5 |
| Bulk density (g/cm³) | 0.5 |
| Settled density (g/cm³) | 0.59 |
| Carr Index (%) | 15 |
| Hausner Index | 1.18 |
| True density (g/cm³) | 1.488 |
| Porosity (%) | 66.3 |
| Diameter (mm) | 3.1 |
| Solubility (s) | 24 |
| Aspect ratio | 0.72 |
| Flow (g/s) | 76.6 |
| Brittleness (%) | 5.84 |
| Humidity (%) | 4.28 |
| Color scale (L) | 49.5 |
| Color scale (a) | 11.8 |
| Color scale (b) | 27.3 |
| Color scale (c) | 29.7 |
| Color scale (h) | 66.7 |

### Example 4 Method for the Production of Granular Food Product from Coffee Powder with Roasted and Micro-Milled Coffee at Compression Conditions of 25 MPa

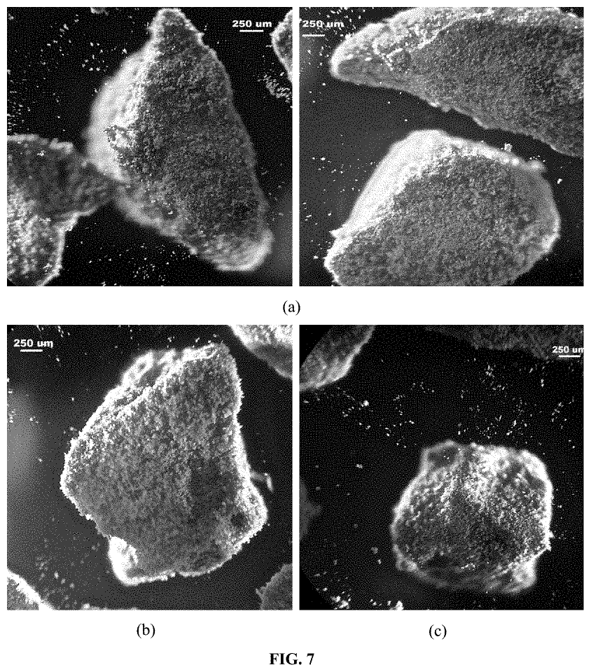

The particulate food material used in this example was a coffee powder (FIG. 7) that was previously spray dried (particle size 0.05 mm-0.5 mm) obtained by air injection between 1 gph-5 gph, followed by spray drying at air inlet 150° C.-620° C. and air outlet 60° C.-210° C. with atomization pressure between 10 Bar-30 Bar (1,000 kPa-3,000 kPa).

To the dry powder obtained, roasted and micro-ground coffee was added between 3%-10% using an overturning mixer for 15 minutes and subjected to dry compression, in particular ingot compression in a 1-station single-punch tablet press (diameter 25.4 mm, height 3.6 mm, 1.6 g, porosity 45%) with a compression pressure of 25 MPa at room temperature and relative humidity around 60%.

The ingots obtained were subjected to comminution coupled to a #8 stainless steel mesh and subsequent fractioning by meshes larger than #30. A granular material characterized by having the resulting properties listed in Table 5 and FIG. 7 is obtained.

TABLE 5

| Property | Product 4 |
|---|---|
| Compressibility (%) | 11.6 |
| Bulk density (g/cm³) | 0.45 |
| Settled density (g/cm³) | 0.5 |
| Carr Index (%) | 11.1 |
| Hausner Index | 1.13 |
| True density (g/cm³) | 1.463 |
| Porosity (%) | 69.5 |
| Diameter (mm) | 3.3 |
| Solubility (s) | 22 |
| Aspect ratio | 0.7 |
| Flow (g/s) | 85 |
| Brittleness (%) | 9.3 |
| Humidity (%) | 5.24 |
| Color scale (L) | 55.3 |
| Color scale (a) | 13.3 |
| Color scale (b) | 29.8 |
| Color scale (c) | 32.6 |
| Color scale (h) | 65.8 |

### Example 5 Method for the Production of Granular Food Product from Cocoa Powder with Lubricant and Disintegrants at Compression Conditions of 25 MPa

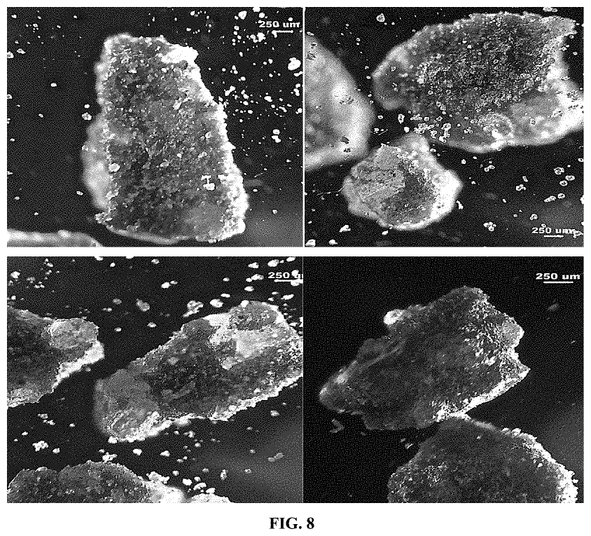

The particulate food material is a cocoa-based powder (FIG. 8) with several sweetening, flavoring and other agents (particle size 0.05 mm-0.5 mm) that has been obtained from natural liquid cocoa extract.

Lubricant and disintegrants of less than 1% were added to the dry powder obtained using an overturning mixer for 15 minutes and subjected to ingot processing in a 1-station single-punch tablet press (diameter 25.4 mm, height 5 mm, 3.0 g, porosity 25%) with a compression pressure of 25 MPa at room temperature and relative humidity of about 70%.

The ingots obtained were subjected to comminution coupled to a #8 stainless steel mesh and subsequent fractioning through meshes larger than #30. A granular material is obtained characterized by having the resulting properties listed in Table 6 and FIG. 8.

TABLE 6

| Property | Product 5 |
|---|---|
| Compressibility (%) | 15.3 |
| Bulk density (g/cm³) | 0.59 |
| Settled density (g/cm³) | 0.67 |
| Carr Index (%) | 11.8 |
| Hausner Index | 1.13 |
| True density (g/cm³) | 1.505 |
| Porosity (%) | 60.9 |
| Diameter (mm) | 4.5 |
| Solubility (s) | 15 |
| Aspect ratio | 0.72 |
| Flow (g/s) | 79.9 |
| Brittleness (%) | 7.2 |
| Humidity (%) | 2.61 |
| Color scale (L) | 47.6 |
| Color scale (a) | 10.6 |
| Color scale (b) | 17.2 |
| Color scale (c) | 13.9 |
| Color scale (h) | 58 |

### Example 6 Method for the Production of Granular Food Product from Agglomerated Coffee at 50 MPa Compression Conditions

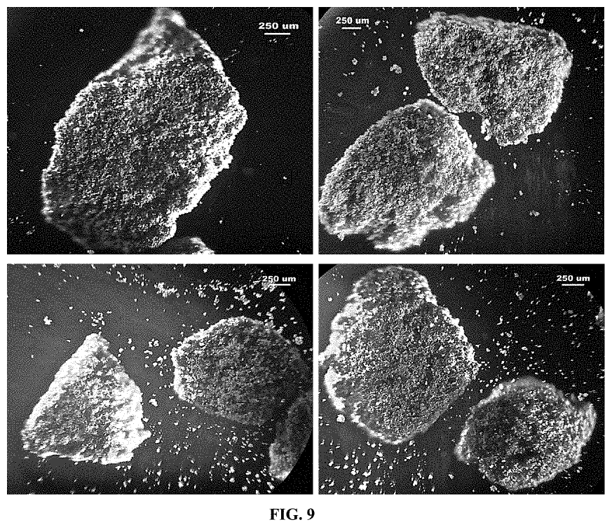

The particulate food material used in this example was agglomerated coffee material (FIG. 9) (particle size 0.2 mm and 2 mm) obtained by addition of water vapor in an agglomeration column.

To the dry agglomerated material, no additives are added and it was subjected to a dry compression stage, in particular to a 16-punch rotary tablet press (diameter 25.4 mm, height 6.2 mm, 3.5 g, porosity 25%) was compressed with a compression pressure of 50 MPa at room temperature and relative humidity around 40%.

The ingots obtained were subjected to comminution coupled to a #8 stainless steel mesh and subsequent fractioning through meshes larger than #30. The resulting granular material is characterized by the properties listed in Table 7 and FIG. 9.

TABLE 7

| Property | Product 6 |
|---|---|
| Compressibility (%) | 12.9 |
| Bulk density (g/cm³) | 0.49 |
| Settled density (g/cm³) | 0.56 |
| Carr Index (%) | 11.8 |
| Hausner Index | 1.13 |
| True density (g/cm³) | 1.407 |
| Porosity (%) | 65.2 |
| Diameter (mm) | 3.6 |
| Solubility (s) | 22 |
| Aspect ratio | 0.7 |
| Flow (g/s) | 52.3 |
| Brittleness (%) | 7.4 |
| Humidity (%) | 6.4 |
| Color scale (L) | 24.5 |
| Color scale (a) | 10.3 |
| Color scale (b) | 3 |
| Color scale (c) | 10.7 |
| Color scale (h) | 16.3 |

### Example 7 Method for the Production of Granular Food Product from Coffee Powder by Nitrogen Injection at 80 MPa Compression Conditions

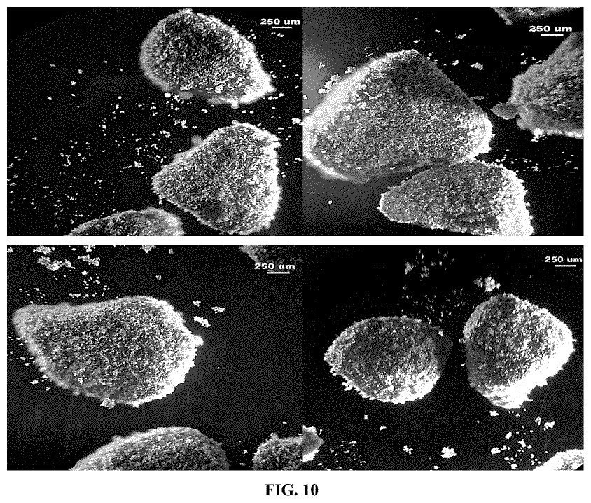

The starting material is spray dried coffee powder (FIG. 10) (particle size 0.05 mm-0.5 mm) which was obtained by nitrogen injection between 1 gph-5 gph, followed by spray drying at air inlet 150° C.-260° C. and air outlet 60° C.-120° C. with atomization pressure between 10 Bar-30 Bar (1,000 kPa-3,000 kPa).

No lubricant was added to the dry powder obtained and it was subjected to dry compression, in particular ingot compression in a 16-punch rotary tablet press (diameter 8.8 mm, height 3.8 mm, mass 0.2 g, porosity 30%) with a compression pressure of 80 MPa at room temperature and relative humidity around 35%.

The ingots obtained were subjected to comminution coupled to a #6 stainless steel mesh and subsequent fractioning through meshes larger than #30. After this method, the granular food product is subjected to coating by means of microdroplet spraying in a rotary tulip with coffee oil, between 0.05% and 10% WN. A granular material characterized by the resulting properties listed in Table 8 and FIG. 10 is obtained.

TABLE 8

| Property | Product 7 |
|---|---|
| Compressibility (%) | 10 |
| Bulk density (g/cm³) | 0.56 |
| Settled density (g/cm³) | 0.62 |
| Carr Index (%) | 9.8 |
| Hausner Index | 1.11 |
| True density (g/cm³) | 1.467 |
| Porosity (%) | 61.8 |
| Diameter (mm) | 2.9 |
| Solubility (s) | 30 |
| Aspect ratio | 0.71 |
| Flow (g/s) | 40 |
| Brittleness (%) | 12 |
| Humidity (%) | 6.5 |
| Color scale (L) | 52 |
| Color scale (a) | 15.1 |
| Color scale (b) | 30.6 |
| Color scale (c) | 34.1 |
| Color scale (h) | 63.5 |

### Example 8 Method for the Production of Granular Food Product from Coffee Powder at 12 MPa Compression Conditions

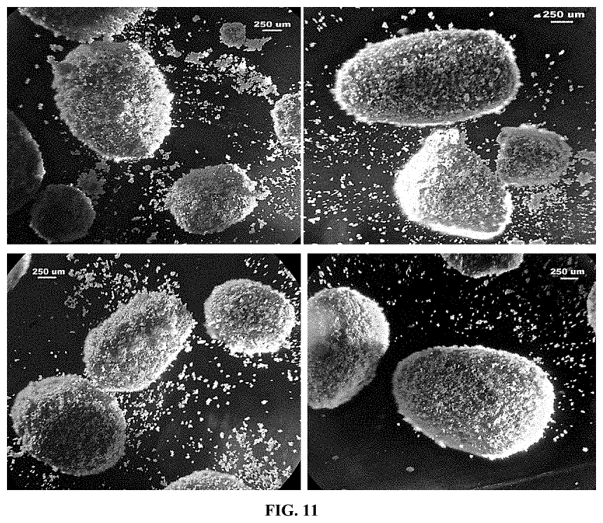

The starting material is spray dried coffee powder (FIG. 11) (particle size 0.05 mm-0.5 mm) which has been obtained by air injection between 1 gph-5 gph, followed by spray drying at air inlet 150° C.-620° C. and air outlet 60° C.-120° C. with atomization pressure between 10 Bar-30 Bar (1,000 kPa-3,000 kPa).

No additives are added to the dry powder obtained and it is injected in a 16-punch rotary tablet press (diameter 24 mm, height 4.5 mm, mass 2.2 g, porosity 50%) with a compression pressure of 12 MPa at room temperature and relative humidity around 50%.

The ingots obtained were subjected to comminution coupled to a #8 stainless steel mesh and subsequent fractioning by meshes larger than #30. A granular material characterized by having the resulting properties listed in Table 9 and FIG. 11 is obtained.

TABLE 9

| Property | Product 8 |
|---|---|
| Compressibility (%) | 13.2 |
| Bulk density (g/cm³) | 0.48 |
| Settled density (g/cm³) | 0.55 |
| Carr Index (%) | 12.5 |
| Hausner Index | 1.14 |
| True density (g/cm³) | 1.458 |
| Porosity (%) | 66.8 |
| Diameter (mm) | 2.4 |
| Solubility (s) | 18.5 |
| Aspect ratio | 0.75 |
| Flow (g/s) | 65.2 |
| Brittleness (%) | 52.3 |
| Humidity (%) | 4.9 |
| Color scale (L) | 47.2 |
| Color scale (a) | 14 |
| Color scale (b) | 31 |
| Color scale (c) | 34.1 |
| Color scale (h) | 65.7 |

### Example 9 Method for the Production of Granular Food Product from Coffee Powder Extracted at Low Temperatures at Compression Conditions of 20 MPa

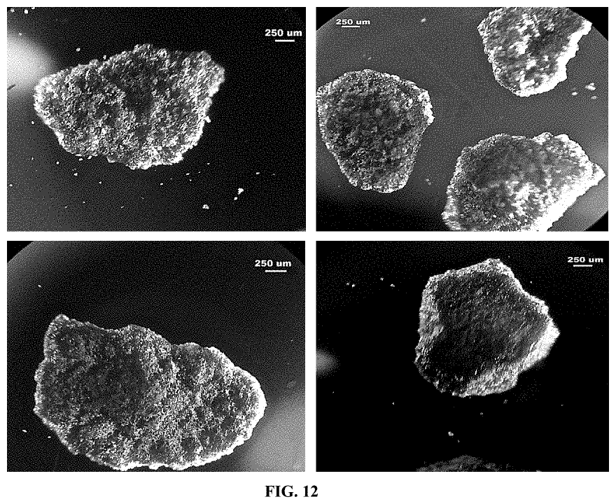

The particulate food material is a food powder (particle size 0.05 mm-0.5 mm) obtained by drying a “Cold Brew” extract (FIG. 12), extracted at low temperatures between 2° C. and 40° C. which is then spray dried with coffee (particle size 0.05 mm-0.5 mm) with an air inlet temperature of 150° C.-620° C. and air outlet of 60° C.-10° C.2 with atomization pressure between 10 Bar-30 Bar (1,000 kPa-3,000 kPa).

The dry powder obtained was subjected to ingot processing in a 1-station single-punch tablet press (diameter 25.4 mm, height 4 mm, 2.5 g, porosity 30%) with a compression pressure of 20 MPa at room temperature and relative humidity of about 75%.

The ingots obtained are subjected to comminution coupled to a #6 stainless steel mesh and subsequent fractioning by meshes larger than #30. A granular material characterized by the resulting properties listed in Table 10 and FIG. 12 is obtained.

TABLE 10

| Property | Product 9 |
|---|---|
| Compressibility (%) | 19.9 |
| Bulk density (g/cm³) | 0.35 |
| Settled density (g/cm³) | 0.44 |
| Carr Index (%) | 19.5 |
| Hausner Index | 1.24 |
| True density (g/cm³) | 1.388 |
| Porosity (%) | 74.6 |
| Diameter (mm) | 3 |
| Solubility (s) | 34 |
| Aspect ratio | 0.72 |
| Flow (g/s) | 81.4 |
| Brittleness (%) | 1.5 |
| Humidity (%) | 7.2 |
| Color scale (L) | 21.4 |
| Color scale (a) | 5.6 |
| Color scale (b) | 1 |
| Color scale (c) | 5.7 |
| Color scale (h) | 10.1 |

### Example 10 Method for the Production of Granular Food Product from Coffee Powder at Compression Conditions of 25 MPa with Reprocessing

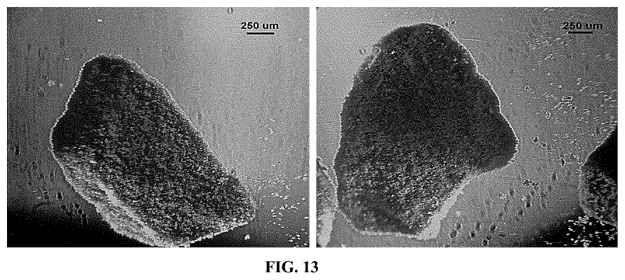

The starting material is spray dried coffee powder (FIG. 13) (particle size 0.05 mm-0.5 mm) obtained by air injection between 1 gph-5 gph, followed by spray drying at air inlet 150° C.-620° C. and air outlet 60° C. −120° C. with atomization pressure between 10 Bar-30 Bar (1,000 kPa-3,000 kPa).

No additives were added to the dry powder obtained, and it was subjected to ingot processing in a 16-punch rotary tablet press (diameter 25.4 mm, height 3.9 mm, 3 g, porosity 20%) with a compression pressure of 25 MPa at room temperature and relative humidity around 40%.

The ingots obtained were subjected to comminution coupled to a #8 stainless steel mesh and subsequent fractioning through meshes larger than #30. The coarse fraction retained between 250 μm-1,000 μm was subjected to reprocessing using the above compression and fractioning procedures. A granular material characterized by having the resulting properties listed in Table 11 and FIG. 13 is obtained.

TABLE 11

| Property | Product 10 |
|---|---|
| Compressibility (%) | 7.7 |
| Bulk density (g/cm³) | 0.58 |
| Settled density (g/cm³) | 0.62 |
| Carr Index (%) | 7.2 |
| Hausner Index | 1.08 |
| True density (g/cm³) | 1.485 |
| Porosity (%) | 61.1 |
| Diameter (mm) | 2.95 |
| Solubility (s) | 28 |
| Aspect ratio | 0.73 |
| Flow (g/s) | 97.1 |
| Brittleness (%) | 3.6 |
| Humidity (%) | 4.9 |
| Color scale (L) | 54.5 |
| Color scale (a) | 12 |
| Color scale (b) | 27.4 |
| Color scale (c) | 30.1 |
| Color scale (h) | 66.4 |

### Example 11 Method for the Production of Granular Food Product from the Fine Fractions Generated in the 25 MPa Compression and Comminution Process

The starting material is spray dried coffee powder (FIG. 12) (particle size 0.05 mm-0.5 mm) which has been obtained by air injection between 1 gph-5 gph, followed by spray drying at air inlet 150° C.-620° C. and air outlet 60° C.-120° C. with atomization pressure between 10 Bar-30 Bar (1,000 kPa-3,000 kPa).

No additives are added to the dry powder obtained and it is subjected to ingot processing in a 16-punch rotary tablet press (diameter 25.4 mm, height 3.9 mm, 3 g, porosity 20%) with a compression pressure of 25 MPa at room temperature and relative humidity of around 45%.

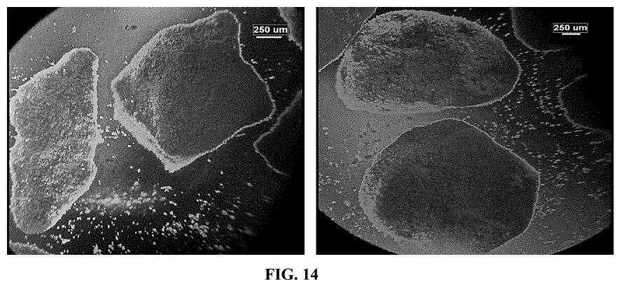

The ingots obtained were subjected to comminution coupled to a #8 stainless steel mesh and subsequent fractioning through meshes larger than #30. The fine fractions smaller than 250 μm were subjected to reprocessing using the previous compression and fractioning procedures. A granular material characterized by having the resulting properties listed in Table 12 and FIG. 14 is obtained.

TABLE 12

| Property | Product 11 |
|---|---|
| Compressibility (%) | 11.5 |
| Bulk density (g/cm³) | 0.49 |
| Settled density (g/cm³) | 0.56 |
| Carr Index (%) | 11 |
| Hausner Index | 1.12 |
| True density (g/cm³) | 1.455 |
| Porosity (%) | 66.2 |
| Diameter (mm) | 2.85 |
| Solubility (s) | 26 |
| Aspect ratio | 0.72 |
| Flow (g/s) | 69.5 |
| Brittleness (%) | 4.6 |
| Humidity (%) | 4.9 |
| Color scale (L) | 59.7 |
| Color scale (a) | 13.2 |
| Color scale (b) | 31.7 |
| Color scale (c) | 34.3 |
| Color scale (h) | 67.3 |

### Example 12: Results Analysis—Color

As seen in Examples 1 to 11, which include the color scale values, wherein the color space can be described as a method of expressing the color of an object using some type of notation, such as numbers. The International Commission on Illumination (Commission Internationale de l'Eclairage—CIE—in French) uses the CIE parameters L*a*b*, and CIE L*C*h*, to communicate and express the color of an object. In this color space, L* indicates lightness, C* represents chroma or saturation, and h* is the hue angle, a and b represent the intensity of green and blue. In particular, in the three-dimensional color space it is observed that the granulated food materials obtained by the method of this invention are a little lighter, greener, bluer, with less chroma and a little more hue than the source used as seen in the parameters L, a, b, c and h.

TABLE 13
Comparative data luminosity of the product vs. Starting product

| | | L* food | |
|---|---|---|---|
| | L* starting | product | Increased |
| | product | obtained | brightness |
| Product 1 | 40.7 | 50.4 | 24% |
| Product 2 | 40.7 | 47.9 | 18% |
| Product 3 | 40.7 | 49.5 | 21% |
| Product 4 | 46.1 | 55.3 | 20% |
| Product 5 | 46.1 | 52 | 13% |
| Product 6 | 40.7 | 47.2 | 16% |
| Product 7 | 40.7 | 54.5 | 34% |
| Product 8 | 40.7 | 59.7 | 47% |

### Example 13 Comparative Analysis of the Sensory and Chemical Profile of Different Samples of Granulated Food Material

Sample 1: Coffee powder with addition of lubricant and disintegrant
Sample 2: Coffee powder without additives
Standard (100): Powdered sample without passing through the invention process

In order to determine the sensory profile, samples were prepared by dissolving 1.5 g in 100 mL of water, as follows:

Table 14 contains the results of the sensory analysis applying a paired comparison of each of the samples versus the Standard (100). According to the results no significant statistical differences were found in the attributes Aroma, Bitter, Body, Overall Impression and Acidity, which shows that with the process of the invention there are no sensory changes in the beverage compared to the starting material.

TABLE 14
Sensory results for the samples analyzed

| | Standard | | |
|---|---|---|---|
| | Powder | Sample 1 | Sample 2 |
| Attribute | (100) | (M1) | (M2) |
| Aroma | 7.1 | 7 | 6.9 |
| Acidity | 5.4 | 5.6 | 5.5 |
| Bitter | 4.8 | 4.7 | 4.7 |
| Body | 6.7 | 6.8 | 6.8 |
| Overall Impression | 7 | 7.1 | 7.1 |

### Beverage Description:

Standard: Coffee with a mild aroma, medium-high acidity, medium body and good flavor.
Sample 1: Coffee with a mild aroma, medium-high acidity, medium body and good flavor.
Sample 2: Coffee with a mild aroma, medium-high acidity, medium body and good flavor.

The samples were evaluated for their content of volatile compounds in the solid, using mass coupled gas chromatography as a technique. For this, 1.5 grams of sample were placed in a 20 mL HS-SPME standard vial and left to stabilize for 1 min at 60° C. with constant agitation (600 rpm). Subsequently, DVB/CAR/PDM (Divinylbenzene/Carboxene/Polydimethylsiloxane) 2 cm—50/30 μm fiber, Supelco (Bellefonte, Pa., USA) was placed in the sample headspace for 40 min at the same conditions described above. At the end of the extraction process, the fiber was removed from the vial and taken to the GC-MS-O injection port for thermal desorption of the analytes at a temperature of 270° C. for 3 min.

Analyses were performed on an Agilent 6890 gas chromatograph (Santa Clara, Calif., USA), coupled simultaneously to a Gerstel ODP 2 programmable temperature olfaction port (Mülheim an der Ruhr, Germany), with olfactometric detection system and a 5973 Network mass spectrometry detector with quadrupole analyzer. The chromatograph was equipped with a standard split/splitless injector and a 0.75 mm inner diameter SPME liner was used. The injection mode used was splitless at a temperature of 270° C., with a pressure pulse of 62 kPa for 3 min. Helium (analytical grade 5.0) was used as carrier gas, at a constant flow rate of 1 mL/min throughout the analysis. At the outlet of the chromatographic column the flow was divided equally between the olfactometry detector and the mass spectrometer.

The chromatographic column used was a 60 m DB-Heavy-wax; 0.25 mm internal diameter and 0.25 μm film thickness (Agilent J&W Scientific). The initial temperature of the chromatographic oven was 50° C. for 3 min, then increased at a rate of 3° C./min to 160° C., finally brought to 250° C. at a rate of 25° C./min and held for 22 min. The temperature of the mass analyzer was maintained at 250° C. and the transfer line at 250° C. The mass range selected, as mass/load ratio, was 40 to 400.

Once the chromatographic profiles were obtained, the data were processed with MassHunter software to obtain the area abundance value. Compound identification was performed by comparing the sample spectra with respect to the NIST 2017 library spectra and calculating the Kovat index values. Statistical analysis of the data was performed with Minitab V16®.

The most influential compounds in explaining sensory variability were 2-propanone, 1-hydroxy-, pyrazine, methyl, furan, 2,3-dihydro-5-methyl-(only in M5), phenol, 2-Furanmethanol, 1H-Pyrrole-2-carboxaldehyde and Pyridine. Among them, the compounds 1H-Pyrrole-2-carboxaldehyde show a positive and statistically significant correlation by Pearson's coefficient r=0.909 (p-value=0.033) with aroma.

The Table 15 describes the attributes associated with the fragrance of the compounds that have the greatest influence in explaining the variability of the samples.

TABLE 15
Compounds with statistically significant correlation with
aroma and its sensory descriptors

| | | Odor/aroma | Functional |
|---|---|---|---|
| CAS | Compound | descriptor | group |
| 1003-29-8 | 1H-Pyrrole-2- | Coffee, smoked | Pyrrole |
| | carboxaldehyde | | |
| 116-09-6 | 1-hydroxy-2-propanone | Pungent, sweet- | Hydroxyketones |
| | | caramel (acidity) | |

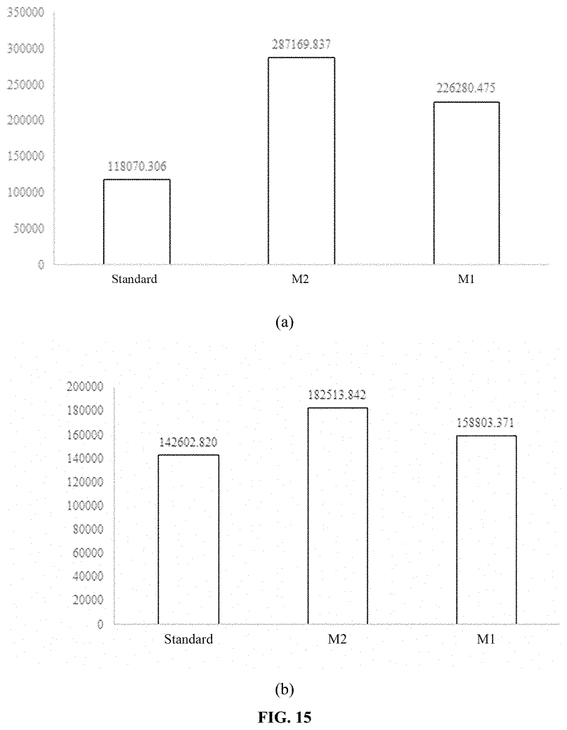

As shown in FIG. 15, the compounds 1H-pyrrole-2-carboxaldehyde and 1-hydroxy-2-propanone associated with coffee odor and pungency are associated with samples 1 and 2 obtained by the method of this invention, on the contrary, in the standard coffee powder it was observed that these compounds are in lower concentration. This aromatic retention is explained by the smaller surface area obtained and intraparticle porosity, which allows its retention and preservation during its shelf life.

1. A method for obtaining a soluble granular food product from a particulate food material comprising:
a) dry-compressing a particulate food material into an ingot; and
b) comminuting the ingot until a soluble granular food material is obtained.

2. The method according to claim 1, wherein the particulate food material is a powder, agglomerated or lyophilized.

3. The method according to claim 2, wherein the particulate food material is obtained from coffee, tea tree, cacao, cocoa, malt, soybeans, quinoa, tea, cinnamon, cloves, fruits or combinations thereof.

4. The method according to claim 2, wherein the particulate food material is soluble coffee powder and is obtained from a coffee extract, extracted at temperatures between 2° C. and 60° C.

5. The method according to claim 1, wherein in dry compression stage (a) is performed in an atmosphere with relative humidity between 25% and 80%.

6. The method according to claim 1, wherein the dry compression of step (a) is performed at compression pressures between 10 MPa and 1,000 MPa.

7. The method according to claim 1, wherein after step (b) the soluble granular food material has an aspect ratio between 0.5 and 0.95.

8. The method according to claim 1, wherein after step (b) the soluble granular food material has a particle size between 50 μm and 20,000 m.

9. The method according to claim 1, wherein after step (b) a step (c) is performed corresponding to fractionating the soluble granular food material to a particle size between 100 μm and 8,000 m.

10. The method according to claim 9, wherein step (c) is performed by means of a vibrating screen, cascade accelerator, mechanical sweep, gravitational acceleration, air streams or combination thereof.

11. The method according to claim 1, wherein the particulate food material has a moisture content of less than 15%.

12. The method according to claim 1, wherein to the particulate food material before entering stage (a) additives are added.

13. The method according to claim 1, wherein steps (a), (b) and (c) are repeated until a product with the desired features is obtained.

14. The method according to claim 1, wherein after step (b) or step (c) the soluble granular food material is coated with an oily substance by microdroplet spraying, wherein the oily substance is selected from fatty acid esters and alcohol, waxes, coffee oil, unsaturated fatty acids, oils of vegetable origin, essential oils, omega 3, carotenes, phytosterols, oleophilic vitamins, or combination thereof.

15. A food product characterized in that it is soluble or partially soluble in an aqueous or partially aqueous medium obtained from powder, agglomerate or lyophilized coffee, soybean, quinoa, tea tree, cocoa, malt, tea, cinnamon, cloves or combinations thereof obtained by the method of claim 1.

16. The food product of claim 15 characterized in that it is coated with an oily substance which is selected from fatty acid esters and alcohol, coffee oil, unsaturated fatty acids, waxes, oils of vegetable origin, essential oils, omega 3, carotenes, phytosterols, oleophilic vitamins, or combination thereof.

17. The food product of claim 15, characterized in that it has a porosity between 60% and 95%, a size between 1 μm and 8,000 m, and a density between 0.1 g/cm³ and 0.8 g/cm³.

18. The food product of claim 15 characterized in that it has a porosity between 70% and 90%, a size between 800 μm and 3,000 μm and a density between 0.3 g/cm³ and 0.6 g/cm³.

19. The food product of claim 15 wherein the aromatic profile is characterized by the compounds 1-H-pyrrole-2-carboxaldehyde and 1-hydroxy 2-propanone.

20. The food product of claim 15 characterized in that it has a higher brightness than the starting product by between 3% and 20%.
